(19) United States
(12) Patent Application Publication
(10) Pub. No.: US 2008/0214142 A1
(43) Pub. Date: Sep. 4, 2008

(54) Emergency Alerting System

(76) Inventors: Michelle Stephanie Morin, (US); Steven Edward Morin, (US)

Correspondence Address: Michelle Morin;Steve Morin, 71 Forest Creek Dr, Ottawa, ON, K2S 1M2, CA

(21) Appl. No.: 11/681,260

(22) Filed: Mar. 2, 2007

(51) Int. Cl. H04M 11/04

(52) U.S. Cl. 455/404.2; 455/404.1

(57) ABSTRACT

An emergency alerting system for permitting a user to secretly send a request for help to multiple parties is described. The system uses a small panic button which may be concealed on the user and which can be activated without an attacker knowing that a call for help has been initiated. The panic button communicates the call for help to a cell phone or Blackberry which in turn sends the call to predetermined recipients using wireless technology. The call or alert message may also include location coordinates using GPS and the time of day.

### FIELD OF THE INVENTION

This invention relates to systems for communicating alert messages to one or more recipients by way of a wireless communicating device and more particularly to such systems wherein a push button for the purpose of initiating the alert message is separate from the communicating device.

### BACKGROUND

The unfortunate and often fatal surprise attack on people of all ages, but in particular young females has grown into a major concern in urban areas. Young women are often advised to stay away from certain communities and to never travel alone especially at night. Frequently attacks on young people are instigated by one or more perpetrators using surprise tactics. This means that the victim is often attacked from behind leaving very little time or opportunity to call for help.

The ubiquitous cell phone is often considered to provide some safety margin but if the attack is sudden and unexpected there is just no time to access the cell phone and then initiate a call for help. Further, if a call for help is made on the cell phone an attacker, determined to go forward with the attack, may take immediate and harmful action sooner rather than later. Thus what might otherwise have been a scare turns into a nightmare.

There is, therefore, a need for an alerting system by which the victim can initiate a call for help without the attacker knowing that the call was made. Accordingly, the problem addressed by this invention is to make a panic button system that allows a user to instantly and easily make a call to the police and/or others, so that they could know where the user is, and be able to send help. This would increase the users chances of survival if ever they get attacked.

The Inventors got the idea for this invention when a young woman in the Inventors' community went missing. They were amazed that there was no way to get help other than by calling 911, which in most cases of abduction or attack the victim doesn't have the time to do. The problem to be solved is to find an alternative mechanism that is simple to use, easy and reliable to activate, and cost effective enough to allow mass wide scale commercial adoption including by youth.

A specific system implemented to solve this problem is called “Jennifer Alert”, in memory of the victim, though other variations of the concept are possible.

### PRIOR ART

The following discussion identifies the prior art of which the Inventors are aware. A description of each reference is provided followed by a brief explanation as to how the present invention distinguishes the reference. All the references deal with personal alert systems generated from a mobile device. None extend this system by decoupling the alert trigger button from the mobile device, as in the present invention, such that it can be easily hidden and activated without having to handle a mobile phone. The system of the present invention is also made cost effective, by using existing devices and systems. It is also unique with the ability to send continuous tracking information to multiple users.

U.S. Pat. No. 7,046,140—Method and System for Alerting a Person to a Situation.

A method of alerting a person to a situation is disclosed. An alert signal is received from a mobile communication device in signal communication with a wireless communication system and an alert system. In response to the alert signal, a database of an alert service is accessed for information relating to the subscriber of the mobile communication device and for information relating to a contact list associated with the subscriber. Information is obtained from the wireless communication system relating to the location of the subscriber, and a communication is made to a member of the subscriber's contact list providing information relating to the subscriber and the situation.

Differences: The main difference is that the above patent relates to a system for sending alerts from a mobile device only. But this would still require the user to pull out the mobile device and activate the alert signal. Jennifer Alert is better because of a wearable panic button that is easy to activate remotely from the cell phone. The cell phone can still be in the user's purse or pocket, saving valuable time and the user can do it without the attacker realizing that a call for help has been made. Also, this system uses GPS in the mobile device, giving an accurate and continuously update of location, not just the location where the button was hit. And, keeping the GPS in the cell phone instead of the button keeps the button small.

U.S. Pat. No. 7,058,409—Personal Safety Net

A personal safety net includes a mobile terminal, a server including a memory to store data, and a communications network to transmit data between the mobile terminal and the server. The mobile terminal may include an image data generator, such as a camera, to generate image data and a voice data generator, such as a microphone, to generate voice data. The mobile terminal further includes an output device to transmit the data to the communications network. The server stores, in its memory, the data transmitted from the output device of the mobile terminal to the network operator server via the communications network. A location data generator, located within either the mobile terminal or the communications network, for example, may be included to generate location data as to the location of the mobile terminal, the location data also being stored in the server.

Differences: The main difference is that this is a system that doesn't use Bluetooth remote activation of the alert system. Jennifer Alert is better because Bluetooth wireless technology makes it is easy to activate remotely from the cellphone. Also, the system of the present invention uses GPS in the mobile device, giving an accurate and continuously updated location, not just the location where the button was hit. And, keeping the GPS in the cellphone instead of the button keeps the alert button small.

U.S. Pat. No. 6,784,833—Personal Surveillance System with Locating Capabilities

A personal surveillance system configured to be worn by an individual includes a communication system configured to record communication files, a locating system configured to determine a location of the personal surveillance system, and a transmitter configured to send the communication files and the location of the personal surveillance system to a remote monitoring station. The locating system includes a satellite system interface configured to determine the location of the personal surveillance system and an alternate positioning system configured to determine the location of the personal surveillance system in at least one situation where the satellite system interface cannot determine the location of the personal surveillance system.

The main difference is that the system of the present invention sends a signal to the police, or anyone else on the contact list. Plus, Bluetooth sends the signal to a cell phone or blackberry instead of the button or the mobile device doing everything. This makes it better because it allows the button to be smaller, allowing it to be easier to wear, and less easy for the attacker to find. It would also benefit by more efficient transmission than satellite based system (power, battery consumption, cost, size).

U.S. Pat. No. 7,016,478—911 Emergency Voice/Data Telecommunication Network

Various embodiments of a 911 emergency voice/data telecommunication network are provided. In one embodiment, the telecommunication network includes: a caller device originating a 911 emergency call having a voice portion, and a data portion, a local service interface, a public voice network, a public data network, and an ESN, wherein the ESN determines the appropriate emergency service organization to receive the 911 emergency call and dispatches the voice portion and data portion thereto. In another embodiment, the telecommunication network includes: a BS, MSC, MPC, and PDE. In another embodiment, the 911 emergency call includes a 911 origination service option. In another aspect of the invention, a method for communicating a mobile-originated 911 emergency call to an appropriate PSAP is provided. In still another aspect of the invention, a caller device for originating the 911 emergency call is provided. The caller device includes: a microphone, a camera, and a 911 button.

The present solution is better because it is activated remotely from the mobile device, can be hidden, and can send it to more than 1 person, not just the police, and it sends an e-mail or text messages, saving time and effort.

### SUMMARY OF THE INVENTION

There exists tracking devices so parents will know where to find their children, but most teenagers don't want their parents to track their every move. The proposed system is only activated by the user when required, and can notify both parents and authorities simultaneously. There are mobile phones and other systems with panic button 911 capabilities, but these still require the phone to be manually activated and spoken into. These also can only notify one party, not multiple.

The invention allows an individual to alert authorities and members of a contact list of a panic/alert situation. The novelty of this invention is it is activated by a small sized panic button, that can easily be disguised, and which communicates, in a preferred embodiment, wirelessly to a nearby personal communication device which in turn uses the existing mobile or fixed communications network to transmits the panic information, including location, on an ongoing basis.

Therefore in accordance with a first aspect of the present invention there is provided a system for sending an emergency alerting message to one or more recipients comprising: a manually operated alerting device; and a wireless communications device adapted to transmit an alert message received from the alerting device, the alert message being selectively transmitted to the one or more recipients over a communications network.

In accordance with a second aspect of the invention there is provided a method of sending an emergency alert message by a system user to one or more recipients over a communications network comprising: initiating an alert message by manually activating a pushbutton on an alert device carried by the system user, the alert device implementing a transmission protocol; and receiving the alert message by a communications device in proximity to the user, the communications device being programmed to transmit the alert message to the one or more recipients over a wireless communications network.

### BRIEF DESCRIPTION OF THE DRAWINGS

The invention will now be described in greater detail with reference to the attached drawings wherein:

FIG. 1 is a high level illustration of alerting solution provided by the invention;

FIG. 2 illustrates the overall concept of the invention including functional blocks, information flows and participating entities;

FIG. 3 illustrates the overall operation of the invention; and

FIG. 4 shows the design concept of the alert button.

### DETAILED DESCRIPTION OF THE INVENTION

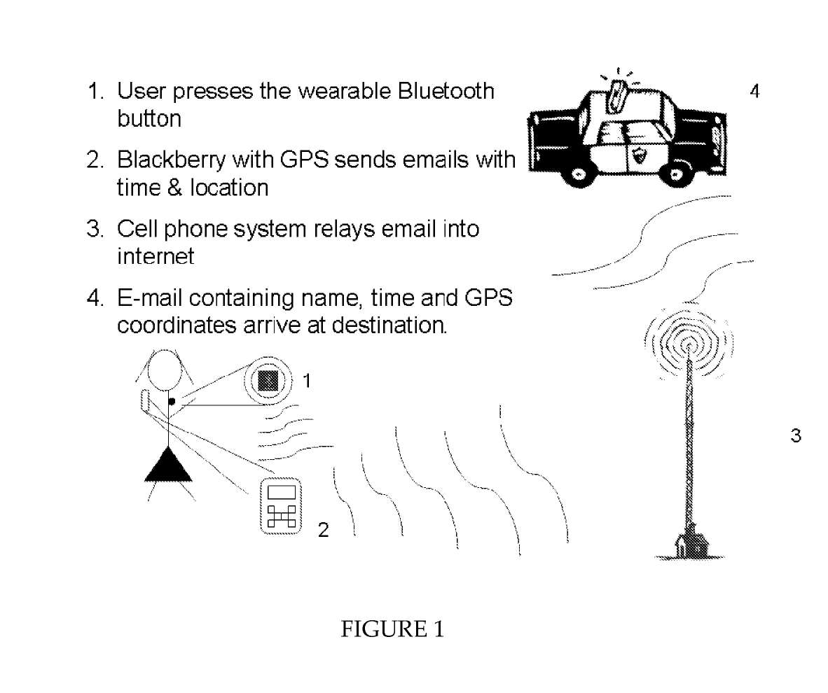

FIG. 1 shows, at a high level, the basic elements of the system according to the present invention. A system user 1 carries, wears or otherwise has easy access to, an alert device (not shown). The alert device has the capability of sending an alert message when a push button (alert button) on the alert device is activated. In a preferred embodiment the Bluetooth communications protocol is used to send a wireless message to the Blackberry 2. It is within the scope of the invention for the alert device to be hard wired to the Blackberry 2 for use in transmitting the alert message. It is also within the scope of the invention to use a cell phone, computer with wireless access, or other PDA in place of the Blackberry. The Blackberry or equivalent relays the alert message via wireless telephony or via email through the internet 3. The alert message, including the name of the system user and preferably the GPS coordinates and real time, is then delivered to one or more pre-designated recipients such as the police, parents, friends, etc.

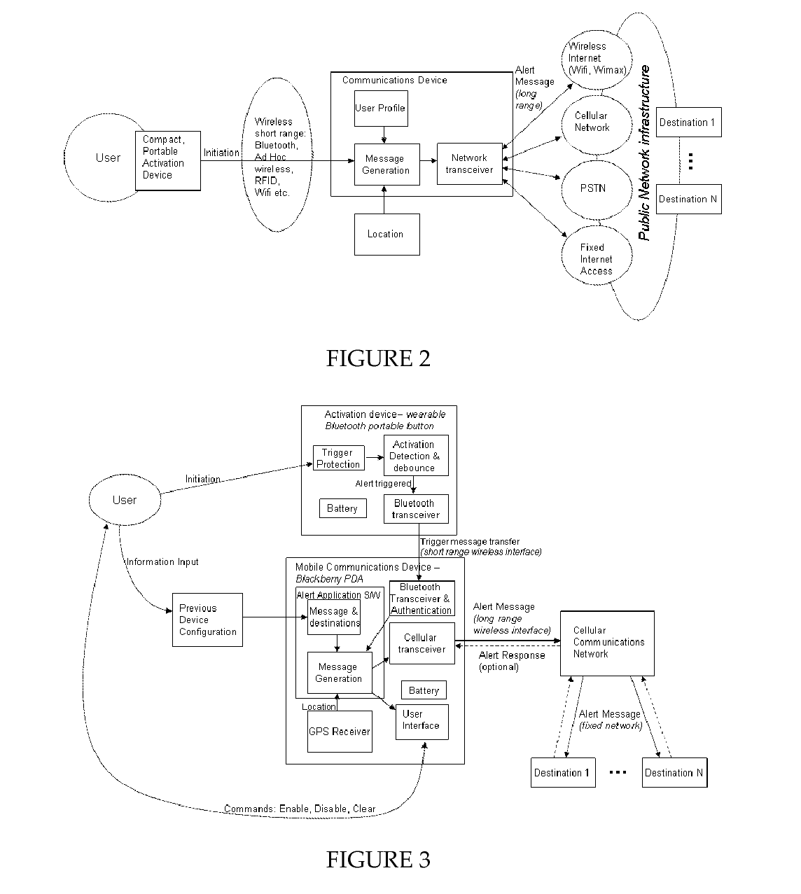

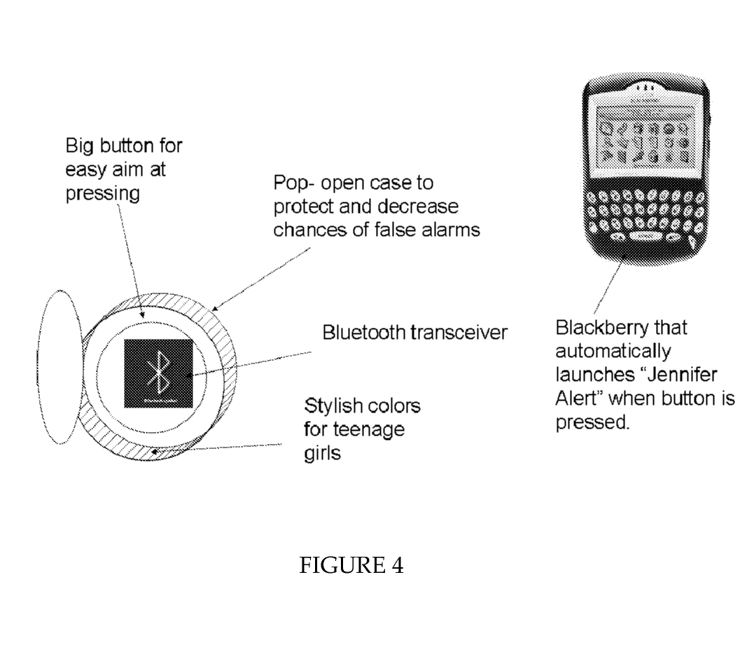

The generic embodiment of the invention is captured in FIG. 2. As indicated above it captures the overall concept including functional blocks, information flows, and the participating entities. The key participating entities within the operational framework are: user, Activation (Alert) Device (panic button), communications device, and communications network. Each functional block and the participating key entities are described in further details below:

a) User: A mobile or fixed service subscriber regardless of its physical access mechanisms. This subscriber will have an account or access connectivity permission using any fixed, mobile or cellular technology communications devices supporting a data interface including CDMA, GSM/GPRS, UMTS, Wifi (802.11×), WiMax etc. (A typical user is a cellphone subscriber.)
b) Destinations: The parties to be contacted with the alert message. The entries to call the appropriate destination number/address can be pre-configured in the communications device by the individual user, and can consist of one or many data interface destinations (email, SMS numbers) or voice call destinations (911, police, home phone etc. . . .)

The following describes the key functional blocks:

c) Activation Device: Any device used as a trigger to activate the alert system. The activation device will act as the Panic button, consisting of an activation switch and a mechanism to notify the host communications device of activation via any form of connection, typically with a short range wireless technology such as Bluetooth (IEEE 802.15.1). It can be connected with any alternative short-range technique not excluding wired methods. The activation device can be designed to be concealable, wearable or otherwise readily accessible for activation in the event of an emergency (such as being attacked). The portable, concealable aspects of the activation device makes it important for the activation device to be distinct and separated from the communications device—since the solution is intended for situations where it is not possible or impractical for the user to directly use the communications device.
d) Communications Device: any data enabled personal communications device including but not restricted to: cellular phones, laptop with wireless access, or Personal Digital Assistant (PDA). Use of such devices in conjunction with internal or adjunct device or mechanism for determining location (such as a GPS receiver) for positioning information is an optional but important aspect of the system. The communications device generates alert messages into the communications network using pre-configured message contents, combined with current GPS location. The messages can be sent as data messages (email, SMS . . . ) or voice message (using pre-recorded or text-to voice features)
e) Communications Network: The communication network through which the device can access the destination party, such as mobile cellular, wifi wireless, internet or PSTN phone system. This system infrastructure may have the ability to determine approximate device location in the event that the communication device is employed without providing location (e.g. GPS) information.

Example Specific Implementation:

One embodiment of the invention is captured in FIG. 3. It captures the overall operation framework including functional blocks, information flows, and the participating entities. Each functional block and the participating entities are described in further details below:

### Key Entities

a) User: A mobile service subscriber on any mobile (e.g. cellular) network. Such subscriber will be using any mobile/cellular technology supporting a data interface including CDMA, GSM/GPRS, UMTS, Wifi (802.11x), WiMax etc.
b) Destinations: The parties to be contacted with the alert message. These entries can be pre-configured in the device by individual users, and can consist of data interface destinations (email, SMS numbers) or voice call destinations (911, police, home phone etc. . . .)

### Key Functional Blocks:

c) Activation Device: The Panic button design provides the key attributes of small size, low power, wearable on or inside of clothing or accessories such that it will be immediately accessible but inconspicuous. The Panic button is a small button disguised as a wearable pin, jewellery accessory etc., with integrated trigger protection that makes it easy to activate if required but protected from being accidentally activated. When activated it uses Bluetooth short range wireless communication to the mobile communications device.

The device includes the following aspects:

1. Trigger Protection: to prevent inadvertent activation, a mechanical or electrical mechanism can be employed to provide positive but rapid and simple activation.
2. Activation Detection: a “switch” function that detects initiation. This can include the capability to recognize, allow and debounce multiple trigger initiations likely to occur in a true panic situation into one “triggered” indication to the transceiver. Multiple activations can be used as a technique to indicate varying levels of alert severity by sending multiple of differing indications to the communications device.
3. Transceiver: a wireless interface connecting the activation device to the host communications device via a short range wireless technology such as Bluetooth (IEEE 802.15.1). It can also be connected with any alternative short-range technique including wired methods, or can even be integrated into the communications device itself.
4. Battery: remote wireless capability requires integrated battery for powering the transceiver and any other electronics used.
d) Communications Device: The Mobile device can be a Blackberry or other Bluetooth capable cellphone with an integrated GPS receiver. The communications device generates alert messages into the communications network using pre-configured message contents, combined with current GPS location. The messages can be sent as data messages or voice message (using pre-recorded or text-to voice features).

The capability of the communications device include:

1. Bluetooth transceiver: Bluetooth or similar short range connection system interfaces to the transceiver in the activation device. To ensure secure and private operation, a particular Bluetooth device is authenticated by the host configuration to ensure only that device will connect to the alert system. This requires pre-configuration of the Bluetooth systems. When an activation signal is received, the transceiver notifies to the Alert Application software of the event.
2. GPS Receiver: The GPS receiver can be included as an integrated function of the mobile communications device. Alternatively, an external adjunct GPS receiver can be connected to the communications device for positioning information, or the system can be implemented with no location information provided from the mobile communications device. Location information is vital to indicated to the communicated authorities the location of the attack/event. Subsequent retransmission of location at intervals allows tracking of the person and device in the event of an abduction or other reason for change of location. This is a unique aspect of the system compared to existing alert solutions.
3. Alert Application Software: This is a software application running in the device that receives indication of an alert trigger, collects the current location information, and formulates alert messages to be sent over the communications network. The destinations and alert message contents are pre-provisioned by the user. In the event of activation, messages are sent to the network at pre-programmed intervals until the alert state is cancelled by the user via the device user interface. Text or graphical notification can also be provided on the screen of the device for user notification of the alert status.
4. Cellular transceiver: the normal device interface is used to send the alert messages.
5. User Interface: Visual display screen and user input (keyboard etc) are used to interface between the user and the Alert application software. The use of the device keyboard and display allows the system to be enabled, disabled, and an activated alter to be cleared. These commands can be protected behind a security password to prevent unauthorized control of the system.
6. Battery: for mobile device operation.

e) Communications Network: The communication network through which the device can access the fixed network—internet or phone system. This system infrastructure can have the ability to determine approximate device location in the event that the system is employed without GPS information.

Other Functional Aspects of the System:

Device Configuration: The communication device is configured with information which is stored user configurable message content to be sent when the alert is triggered, such as an email containing “PANIC: this is Michelle Morin, home phone # xxx-xxxx. This is an emergency—please send help”. The destinations to which the message is to be sent are also configurable. The message type(s) can also be configured—email, SMS, voice etc., and any desired message to be displayed on the device user interface can be configured.
Alert Response: An optional capability is for the contacted destination parties to respond to the communications device to acknowledge receipt or other response.

This following describes the method of using the invention in the above embodiment. The embodiment of the invention is a mobile, wearable panic button. The system has been called “Jennifer Alert” by the inventors, in memoriam of a teenager by the name of Jennifer Teague who was abducted and murdered in Ottawa Ontario in 2005. She was in possession of a cellphone, but did not have time to use it. Hence the idea is to have a simple way that messages can be sent from cellphone devices in the person's possession, such as in a pocket, purse or packsack, but have the activation button easily reachable and disguised from the attacker such that activation of it can be done discretely without being noticed. The messages sent would contain a panic message, the time, and the location of the unit at the time of transmission by sending the GPS coordinates. These messages can be sent repeatedly at a predetermined interval, which will allow a person being moved to be tracked.

This system can be operated as a branded service feature from a mobile network operator, or may operate over a generic mobile service from a user configurable mobile device operating without the knowledge or explicit participation of the mobile operator.

The user needs to program the message contents and destinations into the device to prepare the system for operation. The mobile device can be provided with default messages such as “Panic—send help to this location”, and default destinations such as a local police number or 911 for voice messages. Multiple destinations can be supported, allowing a one to many broadcast for help.

The mobile device must have a mechanism to connect to the panic button over a short range. The typical example cited is using Bluetooth due to its low cost, low power, and small size of transmitter that can be embedded in the wearable panic button. Both the panic button and the mobile device would need to be powered on and enabled via the device user interface for the system to be armed.

The Panic Button is intended to be placed at an easy to reach location. This can be on clothing, in a pocket, be integrated into another Bluetooth device such as a headset, or even be enabled as a button on the mobile device itself. It can be disguised to be discrete so as not to draw attention before, during, or after activation.

If a panic event occurs, the user will remove the trigger protection and activate the button. This will send a signal to the mobile device, which will receive the activation and initiate “Jennifer Alert” software in the device. This software will interface to an embedded or external GPS receiver (if present and active) to gather current location information. This information is embedded into the preconfigured the Panic message that then gets transmitted to the configured destinations over the mobile network infrastructure.

The messages will continue to be sent for a configurable number of times or until the Jennifer Alert program in the mobile device is disabled or the Alert cleared. Enabling, disabling and clearing of triggered Alerts would be protected by an optional security password to prevent unauthorized control of the system. When activated, the Jennifer Alert system can also disable the device power-off button and other aspects of controlling the mobile device to prevent intentional or accidental disabling of the mobile device.

Responses to alert messages received can optionally be sent to the mobile device by the destination parties.

Appropriate response by the contacted authorities is now possible. Use of data messages such as SMS or email leaves a recorded log of the messages and times for subsequent analysis.

The following key advantages over existing solutions, as set out in Reference Table 1 below, quantifies advantages of the technologies described here:

1) Standard mobile phones do not offer an effective level of protection during certain emergency situations, due to the need to dial a destination number or address and speak or type into the device, both of which may not be possible. In some cases the user may not even know their current location. This system allows simple activation, discrete operation, automatic location transmission, and many-to-one alert messages that can improve the response time for assistance. Unlike a standard 911 call, this system will continue to transmit messages with accurate and updated location information for as long as the system is activated. The system can be enabled using standard low cost commercially available Bluetooth, mobile device, and GPS technologies, thus enabling very cost effective implementation.
2) Personal panic systems employing the use of EPIRB satellite systems are physically very large, prohibitively expensive for wide scale personal use, and operate on tightly controlled and scarce RF spectrum. Activation can take up to several hours to be received by the satellite system, and will be dependent on atmospheric conditions such as storms. Activation (inadvertent or intentional) triggers response from the coast guard—hardly the proper authorities for a personal situation in a residential or rural environment.
3) Walkie-talkies are commonly used by parents for short range communications with their children within a local neighborhood range. However the operational range is extremely limited, subject to line of sight interference from building, trees, and hills, and still requires obvious voice activation and for communication of location. A parent can now provide a mobile device to the child, confident that the panic system will work in the very wide coverage of the cellular system.
4) There are tracking devices (e.g. the Trimble TrimTrac Personal Tracking device designed for automobile tracking systems) that enable parents will know where to find you at any time, but many users and parents don't wish a record to be kept to track their every move. This approach also requires a large, special purpose, and expensive device to be carried by the user. The Jennifer Alert system makes use of existing common personal communications devices.
5) Mobile Communications systems sometimes support the capability to use the mobile network device location information (based on cell location) to track movement of users. This enables tracking of all movements, not just at times selective by the user, and does not generate an Alert indication to authorities and parents that a panic event has occurred.

TABLE 1
Characteristics of the system components by technology

| | Wifi | Walkie- | Cell | | | Bluetooth |
|---|---|---|---|---|---|---|
| Characteristics | (802.11) | Talkies | phone | EPIRBs | Blackberry | (Class 2) |
| Network Access | Rare | No | Good | Good | Good | Good |
| Programming | Easy | No | Hard | Hard | Medium | Hard (To |
| | | | | | | have the |
| | | | | | | device |
| | | | | | | use it) |
| Range | 100 m | 90 m | Anywhere | Unlimited | Anywhere | 10 m |
| | | | there is | | there is | |
| | | | coverage | | Data link | |
| Cost | 60$ | 40–100$ | 90–400$ | 500–1000$ | 50–500$ | 5–10$ |
| Size | 7.8 mL | 220 mL | 64 mL | 2310 mL | 73.5 mL | 1.2 mL |
| | (6.5 cm × | (16 cm × | (8 cm × | (21 cm × | (10.5 cm × | (1.5 cm × |
| | 4 cm × .3 cm) | 5.5 cm × 2.5 cm) | 4 cm × 2 cm) | 11 cm × 10 cm) | 7 cm × 1 cm) | 3 cm × .28 cm) |
| Power | 4 watts | 2 watts | .125–.25 | 5 watts | Variable | 4 dBm |
| | | | watts | | (similar to | (2.5 mW) |
| | | | | | cell phones) | |
| Other | | | | +1 hour | | |
| | | | | response | | |
| | | | | time and | | |
| | | | | >1 mile | | |
| | | | | accuracy | | |
| Decision | No | No | No | No | Yes | No |

As will be understood this invention's operation requires an activation device and a mobile phone, both operated on batteries which will require periodic changing or recharging. It is also to be noted that if the alert button is moved out of range of the mobile device the trigger cannot be activated.

Such concerns are addressed by the following:

The system can be designed to have the mobile device generate a message to the user via the user interface if it loses contact with the Bluetooth device, or if it senses the signal fading which could be an indication of power problems with the Bluetooth device. If the Bluetooth device moves out of range or the signal fails, a distinct message can be sent with the time and location that this occurred, but with a non-panic indication. This way if the button was taken out of range in a panic situation there will at least be a record of the time and location that this occurred.

The following provides a Blackberry Java Program for the Jennifer Alert system of the present invention.

```
/*
* Jennifer.java
*
*  © <your company here>, 2006–2007
* Confidential and proprietary.
*/
/**
* BasicMail.java
* Copyright (C) 2001–2005 Research In Motion Limited.
*/
package com.rim.samples.docs.basicmail;
import net.rim.blackberry.api.mail.*;
import net.rim.blackberry.api.mail.event.*;
import net.rim.device.api.ui.component.*;
import net.rim.device.api.ui.*;
import javax.microedition.location.*;
import net.rim.device.api.ui.container.*;
public class Jennifer extends UiApplication {
  private Store store;
  static void main (String args[ ])
  {
    Jennifer app = new Jennifer( );
    app.enterEventDispatcher( );
  }
  Jennifer( )
  {
  pushScreen(new JenniferScreen( )); // move into instance vriable
  }
  private class JenniferScreen extends MainScreen
  {
  private LocationProvider _locationProvider;
  private Location _location;
  private int _interval = 5; // change this to change interval
  int count = 0;
  Font f;
  Font[ ] fs;
  JenniferScreen ( )
  {
    try {
      _locationProvider=LocationProvider.getInstance(null);
      _locationProvider.setLocationListener(new LocationListenerImpl(this),
_interval, 1, 1);
  } catch(LocationException e) {e.printStackTrace( );
System.out.println(“LocationException”);
    { catch (IllegalArgumentException e) {
    e.printStackTrace( );System.out.println(“IllegalArgumentException”);}
    // Displaying line with font
    f = Font.getDefault( );
    f = f.derive(Font.EXTRA_BOLD);
    Font.setDefaultFont(f);
    fs = new Font[1];
    fs[0] = f;
    add (new RichTextField(“PANIC”, null, null, fs, 0));
    // --------------------------
    f = f.derive(Font.PLAIN);
    Font.setDefaultFont(f);
  }
  public void showLocation (double lat, double lon) // this gets “called” which means run,
every “interval” ammount of seconds
  {
    deleteAll( );// clears screen
    // Displaying line with font
    f = Font.getDefault( );
    f = f.derive(Font.EXTRA_BOLD);
    Font.setDefaultFont(f);
    fs = new Font[1];
    fs[0] = f;
    add (new RichTextField(“PANIC”, null, null, fs, 0));
    f = Font.getDefault( );
    f = f.Derive(Font.PLAIN);
    Font.setDefaultFont(f);
    // ------------------------- // this adds the text to screen
    add (new LabelField(“Latitude” + lat));
    add (new LabelField(“Longitude” + lon));
    sendEmail(“michi.morin@sympatico.ca”, “SOS”, “Jennifer is in need of help!\n
Latitude: “ + lat + ”, Longitude: ” + lon);
    count = count + 1;
    add (new LabelField(“Number of e-mails sent ” + count));
  }
  public boolean onClose( );
  {
    if(_locationProvider != null)
    {
      _locationProvider.reset( );
      _locationProvider.setLocationListener(null, −1, −1, −1);
    }
    sendEmail(“michi.morin@sympatico.ca”, “Test email” , “Jennifer exited Panic.”);
    return super.onClose( );
  }
  private void sendEmail (String address, String subject, String message)
  {
    Store store = Session.getDefaultInstance( ).getStore( );
    Folder[ ]folders = store.list(Folder.SENT);
    Folder sentfolder = folder[0];
    // Create message.
    Message msg = new Message(sentfolder);
    // Add TO Recipients.
    Address toList[ ] = new Address[1];
    try {
      toList[0]=new Address(address, “Scott Toke”);
    } catch(AddressException e) {
      System.out.println(e.toString( ));
        }
        try {
          msg.addRecipients(Message.RecipientType.TO, toList);
        { catch (MessagingException e) {
          System.out.println(e.toString( ));
        }
        // Add the subject.
        msg.setSubject(subject);
        // Add the message body.
        try {
          msg.setContent(message);
        } catch(MessagingException e) {
        // Handle messaging exceptions.
        {
        // Send the message.
        try {
          Transport.send(msg);
        } catch(MessagingEception e) {
          System.out.println(e.getMessage( ));
        }
        System.out.println(“Email sent successfully.”);
      }
    }
    private class LocationListenerImpl implements LocationListener
    {
      private JenniferScreen_screen;
      LocationListenerImpl(JenniferScreen screen)
      {
        _screen = screen;
      }
      public void locationUpdated(LocationProvider provider, Location location) {
      // add (new LabelField(“Latitude ”+
  location.getQualifiedCoordinates( ).getLatitude( )));
        _screen.showLocation(location.getQualifiedCoordinates( ).getLatitude( ),
          location.getQualifiedCoordinates( ).getLatitude( ));
      }
      public void providerStateChanged(LocationProvider provider, int newState) {
      }
    }
  }
```

While specific embodiments of the invention have been described and illustrated it will be apparent to one skilled in the art that numerous changes and/or variations can be made without departing from the basic concept. It is to be understood that such changes and/or variations, to the extent possible, will fall within the full scope of the invention as defined by the appended claims.

We claim:

1. A system for sending an emergency alert message to one or more recipients comprising:
a manually operated alerting device; and
a wireless communications device adapted to transmit the alert message received from the alerting device, the alert message being selectively forwarded to the one or more recipients over a wireless communications network.

2. The system as defined in claim 1 wherein the manually operated alerting device is separate and removed from the wireless communications device.

3. The system as defined in claim 2 wherein the alert message is transmitted from the alert device to the communications device using wireless communications protocols.

4. The system as defined in claim 3 wherein the communications protocol is one of Bluetooth, Ad Hoc wireless, radio frequency identification (RFID) and Wifi.

5. The system as defined in claim 1 wherein the alerting device is hard wired to the communications device and the alert message is transmitted to the communications device over a hard wire.

6. The system as defined in claim 1 wherein the alerting device has a manually operated pushbutton, the pushbutton being integrated into a concealable unit.

7. The system as defined in claim 6 wherein the pushbutton has trigger protection to prevent unintentional alert message from being initiated.

8. The system as defined in claim 1 further, having Global Positioning Services (GPS) functionality whereby an alert message includes real time position information.

9. The system as defined in claim 8 wherein the GPS functionality is implemented in the communications device.

10. The system as defined in claim 8 wherein the GPS functionality is implemented external to the communications device but providing location information to the communications device

11. The system as defined in claim 8 further having timing functionality whereby the alert message includes the time of day the transmission was sent.

12. The system as defined in claim 1 wherein the communications device is one of a cell phone, Personal Digital Assistant (PDA) and laptop computer with wireless access.

13. The system as defined in claim 1 wherein the one or more recipients include the local police office.

14. The system as defined in claim 8 wherein the alert message is retransmitted at predetermined intervals with each retransmission including current location coordinates.

15. The system as defined in claim 14 wherein the alert message is retransmitted until cleared by the system user.

16. The system as defined in claim 15 wherein clearing of the retransmitted alert message by the system user is password protected.

17. The system as defined in claim 1 wherein the one or more recipients is able to acknowledge receipt of the alert message to the system user.

18. A method of sending an emergency alert message by a system user to one or more recipients over a communications network comprising:
initiating an alert message by manually activating a pushbutton on an alerting device carried by the system user, the alerting device implementing a transmission protocol; and
receiving the alert message by a communications device in proximity to the user, the communications device being programmed to transmit the alert message to the one or more recipients over a wireless communications network.

19. The method according to claim 18 wherein the transmission protocol is a wireless, short range communications protocol.

20. The method according to claim 18 wherein the alert message is transmitted over the wireless network using an email communications protocol.

21. The method according to claim 18 wherein the alert message is transmitted over the wireless network using a voice communications protocol.

22. The method according to claim 18 wherein the alert message includes Global Positioning information and time of day.

23. The method according to claim 18 wherein the alert device is carried in a concealed condition by the system user and may be used to send the alert message to the one or more recipients in an inconspicuous manner.
